(19) United States
(12) Patent Application Publication
(10) Pub. No.: US 2019/0370944 A1
(43) Pub. Date: Dec. 5, 2019

(54) KEYSTONE CORRECTION METHOD AND DEVICE

(71) Applicant: MEDIATEK INC., Hsin-Chu (TW)

(72) Inventor: Tong LI, Hsinchu (TW)

(21) Appl. No.: 16/410,107

(22) Filed: May 13, 2019

(30) Foreign Application Priority Data
May 31, 2018 (CN) 201810556347.2

(51) Int. Cl. G06T 5/00; G06T 15/04; H04N 9/31

(52) U.S. Cl. CPC G06T 5/006; H04N 9/3185; G06T 15/04

(57) ABSTRACT

A keystone correction method for a projection system includes: receiving an instruction for performing keystone correction on an image projected by a projection system; analyzing the instruction to acquire desired adjusted texture mapping area data and texture space data corresponding to the image projected by the projection system, adjusting an initial texture mapping area according to the desired adjusted texture mapping area data, the texture space data and a predetermined rule to obtain an adjusted texture mapping area, and simultaneously performing texture mapping during the adjustment; and performing keystone correction on the image projected by the projection system according to the adjusted texture mapping area, and outputting a texture mapping result through the projection system, thereby enhancing the effects of keystone correction.

This application claims the benefit of China application Serial No. 201810556347.2, filed May 31, 2018, the subject matter of which is incorporated herein by reference.

### BACKGROUND OF THE INVENTION

### Field of the Invention

The invention relates to the technical field of keystone distortion correction for images, and more particularly to a keystone correction method and device for a projection system.

### Description of the Related Art

In common use of a projector, the position of the projector needs to be placed in a right angle with a projection screen as much as possible, otherwise a keystone effect is produced if the perpendicularity between the two is not ensured. In this case, certain technical measures need to be carried out to perform keystone correction to have a projected image appear as a standard rectangle.

When keystone correction is performed in the prior art, offsets in four vertices of a projected image need to be set to change coordinates of the four vertices, and texture mapping is directly performed, i.e., performing the process of mapping texture pixels in a texture space to pixels in a screen space, as shown in FIG. 1 or FIG. 2, thus completing the keystone correction.

However, it is discovered over extended periods of research and development that, a current keystone correction method is capable of rendering a final projection area to appear as a rectangle. However, while mapping filling is conducted for an entire projection area during the process of adjusting a projected image from a trapezoid or an irregular shape to a rectangle, texture distortion is caused due to the asymmetry of triangles located on the two sides of a diagonal line in the irregular shape of the projection area, as shown in FIG. 3. As such, the outcome of such keystone correction does not meet user viewing requirements.

### SUMMARY OF THE INVENTION

One main technical issue to be solved by the present invention is how to provide a keystone correction method and device for a projection system so as to enhance the effect of keystone correction.

To solve the above technical issue, a keystone correction method for a projection system is provided by a technical solution of the present invention. The method includes: receiving an instruction for performing keystone correction on an image projected by a projection system; analyzing the instruction to acquire desired adjusted texture mapping area data and texture space data corresponding to the image projected by the projection system, adjusting an initial texture mapping area according to the desired adjusted texture mapping area data, the texture space data and a predetermined rule to obtain an adjusted texture mapping area, and simultaneously performing texture mapping during the adjustment; and performing keystone correction according the adjusted texture mapping area on the image projected by the projection system, and outputting a texture mapping result through the projection system.

To solve the above technical issue, a keystone correction device for a projection system is provided by another technical solution of the present invention. The device includes a processor and a memory. The memory is stored with a keystone correction program for a projection system. The processor is coupled to the memory. When the keystone correction program for a projection system is invoked, the processor performs the steps of the above keystone correction method.

The present invention provides the following effects. Different from the prior art, the keystone correction method for a projection system includes receiving an instruction for performing keystone correction on an image projected by a projection system, analyzing the instruction, adjusting a texture mapping area of the image projected by the projection system to obtain an adjusted texture mapping area, performing keystone correction according the adjusted texture mapping area on the image projected by the projection system, and outputting a texture mapping result through the projection system. With the above method of the present invention, texture is further adjusted when keystone correction is performed on an image projected by a projection system, thus reducing the level of texture distortion caused by image keystone correction and enhancing the effect of keystone correction.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an application example of a keystone correction method of the prior art;

FIG. 2 is a schematic diagram of another application example of a keystone correction method of the prior art;

FIG. 3 is a schematic diagram of texture distortion of a texture mapping area in a keystone correction method of the prior art;

FIG. 4 is a flowchart of a keystone correction for a projection system according to an embodiment of the present invention;

FIG. 5 is a flowchart of step S12 in FIG. 4;

FIG. 6 is a schematic diagram of dividing an initial texture mapping area into multiple sub-areas in a keystone correction method according to an embodiment of the present invention;

FIG. 7 is a flowchart of step S123 in FIG. 5;

FIG. 8 is a flowchart of step S12 in FIG. 1; and

FIG. 9 is a structural schematic diagram of a keystone correction device for a projection system according to an embodiment of the present invention.

### DETAILED DESCRIPTION OF THE INVENTION

The technical solutions of the embodiments of the present invention are clearly and thoroughly described with accompanying drawings in the embodiments below. It is obvious that the described embodiments are only some but not all embodiments of the present application. On the basis of the disclosed embodiments of the present application, all other embodiments arrived at by a person skilled in the art without involving any inventive skills are to be encompassed within the scope of the present application.

Referring to FIG. 4, FIG. 4 shows a flowchart of a keystone correction method for a projection system according to an embodiment of the present invention. In this embodiment, the projection system refers to a system consisting of a projector and a projection screen. The method includes the following steps.

In step S11, an instruction for performing keystone correction on an image projected by the projection system is received.

In the application of a projector, it is extremely difficult to ensure absolute perpendicularity between the placement position of the projector and a projection plane. In this case, keystone distortion can be caused in an image projected to the projection plane. In the event of such keystone distortion, a “keystone correction” function of the projector can be used to correct the keystone image to thereby display a final standard rectangle.

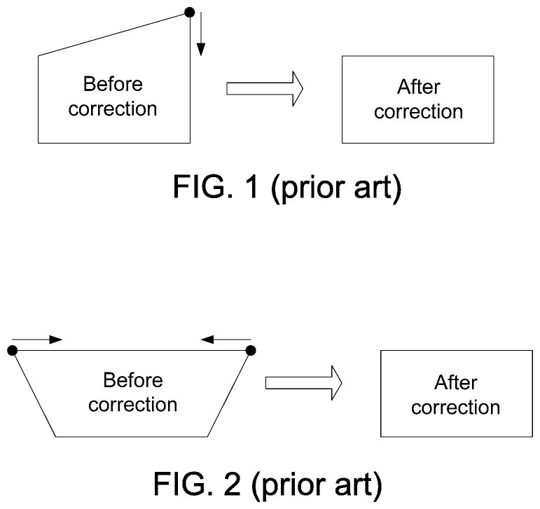

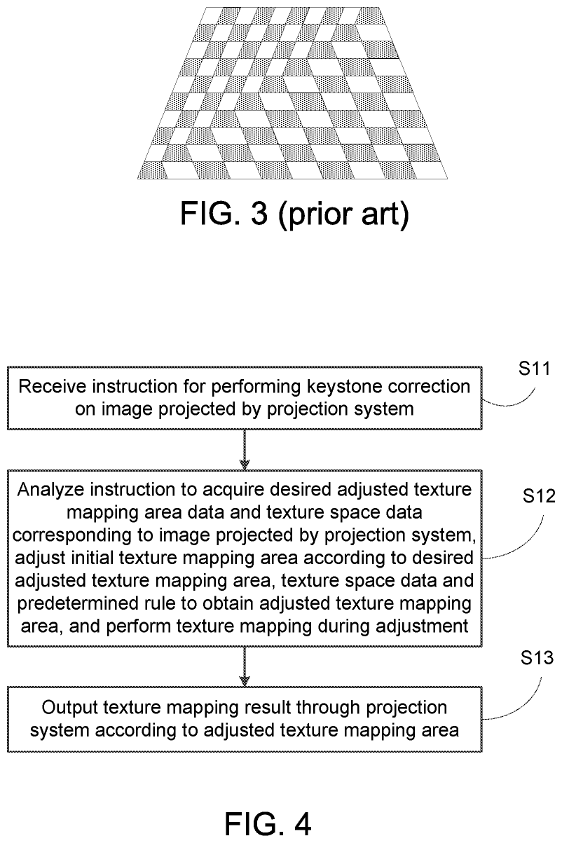

In this embodiment, the instruction for keystone correction refers to an instruction for performing correction by adjusting four corners of a keystone image projected by the projection system. More specifically, by stretching or compressing the four corners of a picture of the keystone image, a standard rectangular image can be obtained, as shown in FIG. 1 and FIG. 2. In this embodiment, the instruction for keystone correction can be automatically issued by the projection system through detecting a projected picture or through detecting a relationship between relative positions of the projector and the projection plane. Alternatively, the instruction can be manually issued by a user through a remote controller or a control panel according to actual requirements, thus enabling the projection system to project a user desired image.

In step S12, the instruction is analyzed to acquire desired adjusted texture mapping area data and texture space data corresponding to the image projected by the projection system, an initial texture mapping area is adjusted according to the desired adjusted texture mapping area data, the texture space data and a predetermined rule, and texture mapping is simultaneously performed during the adjustment.

In this embodiment, the instruction for performing keystone correction includes changes in the angles of the four corners of the keystone image and offsets of vertices of an image area on the projection screen. Further, adjusted texture mapping data corresponding to a keystone corrected image can be obtained according to the instruction, e.g., values of coordinates of the four vertices of the desired adjusted texture mapping area, wherein the coordinates are represented by (x, y) below.

Further, the texture space data corresponding to the image projected by the projection system refers to data indicating the position in texture for each texture pixel. The texture space data is texture data of a rectangle, and is not associated with the shape and position change of the image projected by the projection system. More specifically, the texture space data can be obtained according to the data of the image projected by the projection system, the texture space data is texture coordinates, and the texture coordinates are not associated with the size and shape of a texture object (a corresponding image). Thus, designated texture coordinates can remain functional when there is a change in the size of the texture object. Therefore, the texture coordinates are in standardized values, have a range [0, 1], and are represented by (u, v).

After the desired adjusted texture mapping area data and the texture space data are obtained, the present invention adjusts an initial texture mapping area according to a predetermined rule. More specifically, a certain corresponding relationship exists between the desired adjusted texture mapping area data and the texture space data, and the initial texture mapping area can be adjusted according to the corresponding relationship between the two. Accordingly, the texture mapping area data can correspond to the texture space of a rectangle, so as to alleviate the level of texture distortion of the texture mapping area and prevent texture distortion in the texture mapping area.

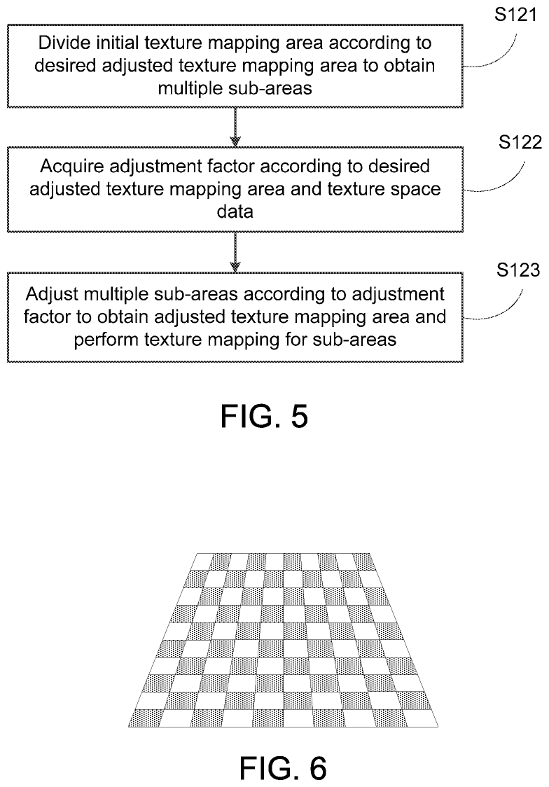

More specifically, when the initial texture mapping area is adjusted according to the above data, an internal region of the initial texture mapping area can be adjusted. Referring to FIG. 5, step S12 further includes the following steps.

In step S121, the initial texture mapping area is divided according to the desired adjusted texture mapping area to obtain multiple sub-areas.

It can be easily understood that, when texture mapping is performed linearly, a trapezoid or other irregular quadrilaterals can occur in the texture mapping area during the adjustment. If texture sampling is performed on the diagonal lines of the trapezoidal texture mapping area, more noticeable texture distortion will appear. When texture mapping is performed on the trapezoidal texture mapping area, the trapezoidal area is divided into two triangles along the diagonal line of the trapezoidal area, and linear interpolation is performed on texture coordinates corresponding to pixels in each triangle during the rasterization stage. Because the two upper and lower triangles of the trapezoid have different linear relationships, texture distortion is caused by texture sampling along the diagonal line of the trapezoidal area when texture mapping is performed linearly. To solve the above issue, in this embodiment, the initial texture mapping is more finely divided into multiple sub-areas, and linear interpolation is performed on each of the sub-areas, such that texture distortion can be reduced to within each partial and small sub-area, thereby significantly reducing the level of texture distortion. Referring to FIG. 6, FIG. 6 shows a schematic diagram of dividing an initial texture mapping area into multiple sub-areas in a keystone correction method for a projection system according to an embodiment of the present invention.

When the initial texture mapping area is divided, the area can be divided into any desired number of areas in a random manner, or can be divided according to a specific rule according to a predetermined method.

In step S122, an adjustment factor is acquired according to the desired adjusted texture mapping area data and the texture space data.

For example, assume that the desired adjusted texture mapping area data is vertex coordinates of the desired adjusted texture mapping area. When the instruction is analyzed, information that the trapezoidal image is to be finally projected into an image having a resolution 1920*080 is obtained. Thus, it is known that, the coordinates of the vertices of the corresponding desired adjusted texture mapping area are (1920, 1080), (1920, 0), (0, 1080), and (0, 0). Because the texture space data is texture coordinates which use standardized values, the adjustment factor can be obtained according to the known information including the vertex coordinates of the desired adjusted texture mapping area and the standardized texture coordinate values, so as to further obtain the vertex coordinates of the sub-areas. Thus, mapping can be performed with respect to sub-areas rather than for the entire area, thereby significantly reducing the level of texture distortion.

In step S123, the multiple sub-areas are adjusted according to the adjustment factor to obtain an adjusted texture mapping area, and texture mapping is performed on the sub-areas.

In this embodiment, conversion can be performed according to an adjustment factor. More specifically, the adjustment factor can be acquired from the corresponding texture mapping area data and the texture space data, and the sub-areas are respectively adjusted after the adjustment factor is acquired.

In one application scenario, the desired adjusted texture mapping area data is the vertex coordinates (x, y) of the desired adjusted text mapping area, and the texture space data is the texture coordinates (u, v) corresponding to the vertex coordinates (x, y) of the desired adjusted texture mapping area.

It should be noted that, the values of u and v of the texture coordinates (u, v) corresponding to the texture space are both within [0.0, 1.0].

It can be easily understood that, since the texture consisting of the texture coordinates is eventually to be projected within the desired adjusted texture mapping area, it is obvious that a certain corresponding relationship exists between the vertex coordinates (x, y) of the desired adjusted texture mapping area and the corresponding texture coordinates (u, v). More specifically, in this embodiment, the above corresponding relationship is quantized through acquiring a transformation matrix as the correction factor, and the corresponding vertex coordinates of the sub-areas in the adjusted texture mapping area are then obtained according to the transformation matrix and the texture coordinates of the vertices of the sub-areas, so as to further adjust the sub-areas and perform mapping for the sub-areas.

More specifically, calculation is performed on the vertex coordinates (x, y) of the desired adjusted texture mapping area and the texture coordinates (u, v) through equation (1) to obtain a transformation matrix

$$[ \begin{matrix}a & d & 0 & g \\ b & e & 0 & h \\ 0 & 0 & 1 & 0 \\ c & f & 0 & 1\end{matrix} ]$$

as the correction factor, wherein equation (1) is

$$[ \begin{matrix}x ω & y ω & 0 & ω\end{matrix} ] = [ \begin{matrix}u & v & 0 & 1\end{matrix} ] [ \begin{matrix}a & d & 0 & g \\ b & e & 0 & h \\ 0 & 0 & 1 & 0 \\ c & f & 0 & 1\end{matrix} ] ,$$

where ω is homogeneous coordinates, and can have a value of 1 in a two-dimensional space or a value between 0 and 1 in perspective projection, and 0 represents a perspective point at infinity.

More specifically, with the coordinates of the four vertices of the texture mapping area being known, and the four corresponding sets of texture coordinates in the texture space are also known, the four sets of coordinates can be substituted into the above equation to obtain the transformation matrix.

It can be easily understood that, after the above transformation matrix is obtained, the corresponding texture coordinates of the sub-areas obtained from dividing the desired adjusted texture mapping area according to a division method, and the corresponding vertex coordinates of the sub-areas in the adjusted texture mapping region are acquired according to equation (1) and the transformation matrix

$$[ \begin{matrix}a & d & 0 & g \\ b & e & 0 & h \\ 0 & 0 & 1 & 0 \\ c & f & 0 & 1\end{matrix} ] ,$$

so as to achieve the adjustment and texture mapping of the sub-areas in the adjusted texture mapping area.

More specifically, in one application scenario, step S121 further includes: equally configuring and dividing borders of the initial texture mapping area according to the vertex coordinates of the desired adjusted texture mapping area to obtain multiple sub-areas.

In this application scenario, the vertex coordinates of the desired adjusted texture mapping area are first determined. After the determination, the four borders of a quadrilateral corresponding to the area are first equally configured, wherein two mutually corresponding borders are equally divided. For example, the adjusted texture mapping area can be divided into m vertices along the horizontal direction and n vertices along the vertical direction, so as to divide the adjusted texture mapping area into m*n sub-areas.

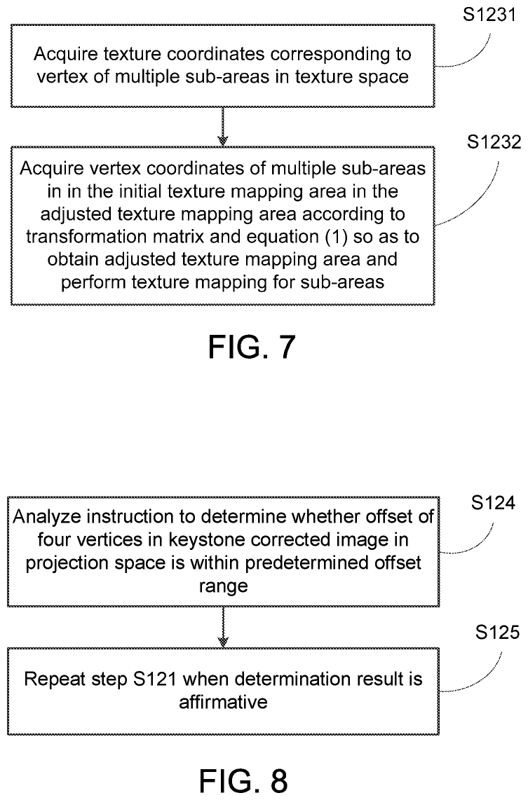

In this application scenario, referring to FIG. 7, step S12 further comprises the following steps.

In step S1231, the texture coordinates corresponding to the vertices of the multiple sub-areas in the texture space are obtained.

More specifically, in this application scenario, texture coordinates corresponding to the vertices of the multiple sub-areas are obtained according to the above division method on the initial texture mapping area.

According to the above example, the initial texture mapping area is divided into m*n sub-areas. At this point, in a texture space corresponding to a rectangle, the corresponding texture coordinates can also be equally divided into m parts in the horizontal direction and equally divided into n parts in the vertical division, so as to further obtain the texture coordinates corresponding to the vertices of the sub-areas according to the division method of the initial texture mapping area.

In step S1232, corresponding vertex coordinates of the sub-areas in the initial texture mapping area in the adjusted texture mapping area are acquired to obtain the adjusted texture mapping area, and texture mapping is performed on the sub-areas.

It can be easily understood that, after the texture coordinates corresponding to the vertices of the sub-areas are obtained, since the transformation matrix is known, it would be easy to obtain the vertex coordinates of the sub-areas, so as to perform positioning of the sub-areas and achieve adjustment and texture mapping of the sub-areas.

In step S13, a texture mapping result is outputted according to the adjusted texture mapping area.

In this embodiment, after the instruction for performing keystone correction on the image projected by the projection system is received, when the shape of the keystone image is adjusted according to the above instruction, the texture mapping area is further adjusted, so as to have the texture mapping area be adjusted along with the adjustment of the keystone image and to output a result through the projection system. With the above method of the present invention, when keystone correction is performed on an image projected by a projection system, texture is at the same time mapped, so as to alleviate the level of distortion caused by image keystone correction and enhance the effect of keystone correction, further enhancing the display effect of the image projected by the projection system and satisfying user viewing requirements.

More specifically, according to the application scenario of the embodiment, after the vertex coordinates of the sub-areas of the adjusted texture mapping area are obtained according to equation (1) and the transformation matrix

$$[ \begin{matrix}a & d & 0 & g \\ b & e & 0 & h \\ 0 & 0 & 1 & 0 \\ c & f & 0 & 1\end{matrix} ] ,$$

the image undergoing keystone is rendered according to the vertex coordinates of the sub-areas and the texture coordinates corresponding to the vertices of the sub-areas, and the keystone corrected image is outputted through the projection system.

More specifically, in one application scenario, the vertices of the adjusted texture mapping area are finely divided to form multiple small sub-areas, and each of the trapezoidal areas consists of two small triangles.

Because the texture coordinates in the texture space are all within the interval range of [0.0, 1.0], the texture coordinates are further similarly finely divided when the adjusted texture mapping area is divided according to the above method. For example, correspondingly, 40 parts are obtained after division along the horizontal direction, and the texture coordinates are respectively 0, 0+1/40.0f, 0+2/40.0f, . . . , and 1.0f.

After the texture coordinates are acquired, the texture coordinates are substituted into the transformation matrix and equation (1) to obtain the vertex coordinates of the small sub-areas obtained from dividing the corresponding adjusted texture mapping area.

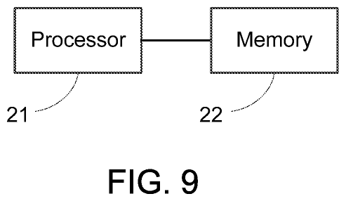

Referring to FIG. 9, in one embodiment, step S12 further includes the following steps.

In step S124, the instruction is analyzed to determine whether offsets of the four vertices of the keystone corrected image in the projection space are within a predetermined valid offset range.

In step S125, when the determination is affirmative, step S121 is repeated.

The offsets of the four vertices are offsets of the four vertices before and after the correction when correction is performed on the keystone image through analyzing the instruction.

The valid offset range can be pre-configured, and is set according to the keystone image projected by the projection system. In one application scenario, the valid offset range in the horizontal direction cannot exceed a half of the width of an area corresponding to the projected image and the valid offset range in the vertical direction cannot exceed a half of the height of an area corresponding to the projected image. The instruction is omitted when the valid offset range is exceeded, whereas the next step is performed when the valid offset range is not exceeded. Alternatively, the valid offset range can have other values set according to actual requirements, and is not specifically limited herein.

FIG. 9 shows a structural schematic diagram of a keystone correction device for a projection system according to an embodiment of the present invention.

In this embodiment, the keystone correction device for a projection system can be a part of the projection system. Alternatively, the keystone correction device for a projection system can be a correction device independent and outside the projection system, and the correction device is connected to the projection system at this point so as to correct an image projected by the projection system.

The keystone correction device for a projection system includes a processor 21 and a memory 22. The memory 22 is stored with a keystone correction program for a projection system. The processor 21 is coupled to the memory 22. When the keystone correction program of the projection system is invoked, the processor 21 performs the steps same as the steps in the keystone correction method for a projection system of the present invention above. Associated details can be referred from the description of the above embodiments, and are omitted herein.

It should be noted that, when the keystone correction device for a projection system performs keystone correction on an image projected by the projection system, texture is at the same time mapped, so as to alleviate the level of distortion caused by image keystone correction and enhance the effect of keystone correction, further enhancing the display effect of the image projected by the projection system and satisfying user viewing requirements.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded with the broadest interpretation so as to encompass all such modifications and similar arrangements and procedures.

What is claimed is:

1. A keystone correction method applied to a projection system, comprising:
receiving an instruction for performing keystone correction on an image projected by the projection system;
analyzing the instruction to acquire desired adjusted texture mapping area data, and texture space data corresponding to the image projected by the projection system, adjusting an initial texture mapping area according to the desired adjusted texture mapping area data, the texture space data and a predetermined rule to obtain an adjusted texture mapping area, and performing texture mapping during adjustment; and
outputting a texture mapping result through the projection system according to the adjusted texture mapping area.

2. The keystone correction method according to claim 1, wherein the step of analyzing the instruction to acquire the desired adjusted texture mapping area data, and texture space data corresponding to the image projected by the projection system, adjusting the initial texture mapping area according to the desired adjusted texture mapping area data, the texture space data and the predetermined rule to obtain the adjusted texture mapping area, and performing texture mapping during the adjustment further comprises:
dividing the initial texture mapping area according to the desired adjusted texture mapping area data to obtain a plurality of sub-areas;
acquiring an adjustment factor according to the desired adjusted texture mapping area and the texture space data; and
adjusting the plurality of sub-areas according to the adjustment factor to obtain the adjusted texture mapping area, and performing texture mapping for the plurality of sub-areas.

3. The keystone correction method according to claim 2, wherein:
the desired adjusted texture mapping area data is vertex coordinates (x, y) of the adjusted texture mapping area, and the texture space data is texture coordinates (u, y) corresponding to the vertex coordinates (x, y) of the desired adjusted texture mapping area; and
the step of acquiring the adjustment factor according to the desired adjusted texture mapping area and the texture space data further comprises:
calculating a transformation matrix
$$[ \begin{matrix}a & d & 0 & g \\ b & e & 0 & h \\ 0 & 0 & 1 & 0 \\ c & f & 0 & 1\end{matrix} ]$$
according to the vertex coordinates (x, y) of the desired adjusted texture mapping area, the texture coordinates (u, v) and an equation, as the correction factor, wherein the equation is
$$[ \begin{matrix}x ω & y ω & 0 & ω\end{matrix} ] = [ \begin{matrix}u & v & 0 & 1\end{matrix} ] [ \begin{matrix}a & d & 0 & g \\ b & e & 0 & h \\ 0 & 0 & 1 & 0 \\ c & f & 0 & 1\end{matrix} ] .$$

4. The keystone correction method according to claim 3, wherein the step of dividing the initial texture mapping area according to the desired adjusted texture mapping area data to obtain the plurality of sub-areas further comprises:
equally configuring and dividing borders of the initial texture mapping area according to the vertex coordinates of the desired adjusted texture mapping to obtain the plurality of sub-areas.

5. The keystone correction method according to claim 3, wherein the step of adjusting the plurality of sub-areas according to the adjustment factor to obtain the adjusted texture mapping area, and performing texture mapping for the plurality of sub-areas further comprises:
acquiring the texture coordinates corresponding to a vertex of the plurality of sub-areas in the texture space;
acquiring the vertex coordinates of the plurality of sub-areas in the initial texture mapping area corresponding to the adjusted texture mapping area to obtain the adjusted texture mapping area, and performing texture mapping on the plurality of sub-areas.

6. The keystone correction method according to claim 5, wherein the step of outputting the texture mapping result through the projection system according to the adjusted texture mapping area further comprises:
rendering the image undergoing keystone correction according to the vertex coordinates of the plurality of sub-areas and the texture coordinates corresponding to the vertex coordinates of the plurality of sub-areas, and outputting an keystone corrected image through the projection system.

7. The keystone correction method according to claim 6, further comprising:
analyzing the instruction, and determining whether an offset of four vertices of the keystone corrected image in the projection space is within a predetermined valid offset range;
when a determination result is affirmative, performing the step of dividing the initial texture mapping area according to the desired adjusted texture mapping area to obtain the plurality of sub-areas.

8. A keystone correction device applied to a projection system, comprising a processor and a memory, the memory stored with a keystone correction program, the processor coupled to the memory, when the keystone correction program of the projection system is accessed, the processor performs steps of:
receiving an instruction for performing keystone correction on an image projected by the projection system;
analyzing the instruction to acquire desired adjusted texture mapping area data, and texture space data corresponding to the image projected by the projection system, adjusting an initial texture mapping area according to the desired adjusted texture mapping area data, the texture space data and a predetermined rule to obtain an adjusted texture mapping area, and performing texture mapping during adjustment; and
outputting a texture mapping result through the projection system according to the adjusted texture mapping area.

9. The keystone correction device according to claim 8, wherein in the step of analyzing the instruction to acquire the desired adjusted texture mapping area data, and texture space data corresponding to the image projected by the projection system, adjusting the initial texture mapping area according to the desired adjusted texture mapping area data, the texture space data and the predetermined rule to obtain the adjusted texture mapping area, and performing texture mapping during the adjustment, the processor further performs steps of:
dividing the initial texture mapping area according to the desired adjusted texture mapping area data to obtain a plurality of sub-areas;
acquiring an adjustment factor according to the desired adjusted texture mapping area and the texture space data; and
adjusting the plurality of sub-areas according to the adjustment factor to obtain the adjusted texture mapping area, and performing texture mapping for the plurality of sub-areas.

10. The keystone correction device according to claim 8, wherein:
the desired adjusted texture mapping area data is vertex coordinates (x, y) of the adjusted texture mapping area, and the texture space data is texture coordinates (u, y) corresponding to the vertex coordinates (x, y) of the desired adjusted texture mapping area; and
in the step of acquiring the adjustment factor according to the desired adjusted texture mapping area and the texture space data, the processor further performs a step of:
calculating a transformation matrix
$$[ \begin{matrix}a & d & 0 & g \\ b & e & 0 & h \\ 0 & 0 & 1 & 0 \\ c & f & 0 & 1\end{matrix} ]$$
according to the vertex coordinates (x, y) of the desired adjusted texture mapping area, the texture coordinates (u, v) and an equation, as the correction factor, wherein the equation is
$$[ \begin{matrix}x ω & y ω & 0 & ω\end{matrix} ] = [ \begin{matrix}u & v & 0 & 1\end{matrix} ] [ \begin{matrix}a & d & 0 & g \\ b & e & 0 & h \\ 0 & 0 & 1 & 0 \\ c & f & 0 & 1\end{matrix} ] .$$
